(19) United States
(12) Patent Application Publication
(10) Pub. No.: US 2015/0379505 A1
(43) Pub. Date: Dec. 31, 2015

(54) USING LIMITED LIFE TOKENS TO ENSURE PCI COMPLIANCE

(71) Applicants: Richard Lee Slater, Sunnyvale, CA (US); Randall Geyer, Mountain View, CA (US); Mugur Stefanescu, Mountain View, CA (US)

(72) Inventors: Richard Lee Slater, Sunnyvale, CA (US); Randall Geyer, Mountain View, CA (US); Mugur Stefanescu, Mountain View, CA (US)

(73) Assignee: Intuit Inc., Mountain View, CA (US)

(21) Appl. No.: 14/320,535

(22) Filed: Jun. 30, 2014

(51) Int. Cl. G06Q 20/36; G06Q 20/02

(52) U.S. Cl. CPC G06Q 20/3674; G06Q 20/027

(57) ABSTRACT

A method comprises receiving, by a payment service from a point of sale (POS) system, a payment request having sale data and a card data token, generating a detokenize and erase request including the card data token, sending the detokenize and erase request to a token service, receiving, by the payment service, card data from the token service in response to the sending the detokenize and erase request, generating a payment process request comprising the sale data and the card data, sending the payment process request to a payment authorization service, receiving a payment response from the payment authorization service in response to the sending the payment process request, and sending the payment response to the POS system.

### BACKGROUND

When processing payment transactions, payment data must be properly handled and protected throughout its life cycle from the point of sale system though all hosted applications. This is generally accomplished through a layered approach to security that meets well-defined access control and data protection (e.g., encryption, tokenization, hashing) requirements. In addition, card swiped data must meet special handling requirements such as mandatory deletion from system memory post-authorization. Applications hosted in the cloud pose significant difficulties meeting all necessary requirements.

### SUMMARY

In general, in one aspect, the invention relates to a method. The method comprising: receiving, by a payment service from a point of sale (POS) system, a payment request comprising sale data and a card data token; generating a detokenize and erase request comprising the card data token; sending the detokenize and erase request to a token service; receiving, by the payment service using a computer processor, card data from the token service in response to the sending the detokenize and erase request; generating a payment process request comprising the sale data and the card data; sending the payment process request to an payment authorization service; receiving a payment response from the payment authorization service in response to the sending the payment process request; and sending the payment response to the POS system.

In general, in one aspect, the invention relates to a non-transitory computer readable medium comprising instructions. The instruction, when executed by a computer processor, perform a method, the method comprising: receiving, by a payment service from a point of sale (POS) system, a payment request comprising sale data and a card data token; generating a detokenize and erase request comprising the card data token; sending the detokenize and erase request to a token service; receiving, by the payment service, card data from the token service in response to the sending the detokenize and erase request; generating a payment process request comprising the sale data and the card data; sending the payment process request to the payment authorization service; receiving a payment response from the payment authorization service in response to the sending the payment process request; and sending the payment response to the POS system.

In general, in one aspect, the invention relates to a system. The system comprising: a token service configured to: receive, from a point of sale (POS) system, a card data tokenize request comprising card data, generate a card data token corresponding to the card data, and send the card data token to the POS system; and a payment service configured to: receive, from the POS system, a payment request comprising sale data and the card data token, generate a detokenize and erase request comprising the card data token, send the detokenize and erase request to the token service, receive, by the payment service, card data from the token service in response to the sending the detokenize and erase request, generate a payment process request comprising the sale data and the card data, send the payment process request to a payment authorization service, receive a payment response from the payment authorization service in response to the sending the payment process request, and send the payment response to the POS system.

Other aspects and advantages of the invention will be apparent from the following description and the appended claims.

### BRIEF DESCRIPTION OF DRAWINGS

FIG. 1 shows a system in accordance with one or more embodiments of the invention.

FIG. 2 shows a flow diagram in accordance with one or more embodiments of the invention.

FIG. 3 shows a flow diagram in accordance with one or more embodiments of the invention.

FIG. 4 shows a flow diagram in accordance with one or more embodiments of the invention.

FIGS. 5A and 5B show an example in accordance with one or more embodiments of the invention.

FIG. 6 shows a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide a method and system for processing online payments in a secure manner. Specifically, embodiments of the invention may be used to process payments using limited life tokens in compliance with the payment application data security standard (PA-DSS) and the payment card industry data security standard (PCI-DSS). Further, limited life tokens are employed to ensure card swipe data is deleted post-authentication.

FIG. 1 shows a diagram of a system in accordance with one or more embodiments of the invention. As shown in FIG. 1, the system includes a sale input device (100), a payment input device (102), a point of sale (POS) system (104), a token service (106), a gateway (108), a payment service (110), and a payment authorization service (112). The sale input device (100), the payment input device (102), and the POS system (104) are governed by the PA-DSS (114). The token service (106), the payment service (108), and the payment authorization service (110) are governed by the PCI-DSS (116). The gateway (108) is out of the scope of both the PA-DSS (114) and the PCI-DSS (116).

In one or more embodiments of the invention, the POS system (104) is a combination of hardware and software that includes functionality to process payments for a business or individual. The POS system (104) is operatively coupled to the sale input device (100) and the payment input device (102). In one or more embodiments of the invention, the sale input device (100) is a combination of hardware and software with functionality to receive sale data and provide the sale data to the POS system (104). In one or more embodiments of the invention, sale data is information that describes a potential financial transaction. The sale data may include, but is not limited to, a transaction amount, a tax amount, and an itemized list of items purchased. In one or more embodiments of the invention, the sale input device (100) is a device used to obtain sale data about a transaction. Examples of sale input devices (100) include, but are not limited to, keyboards, monitors, and touchscreens.

In one or more embodiments of the invention, the payment input device (102) is a combination of hardware and software that includes functionality to provide card data to the POS system (104). In one or more embodiments of the invention, card data is information identifying a payment account of the payer in the transaction. Examples of card data include, but are not limited to, credit card numbers, credit card expiration dates, credit card swipe information, security codes, checking account numbers, personal identification numbers, and cryptographic currency account numbers. Examples of payment input devices (102) include, but are not limited to, credit card magnetic strip readers, near field communication devices, and numeric keypads. Although referred to herein as card data, the term card data is not intended to be limited to information extracted from a debit or credit card.

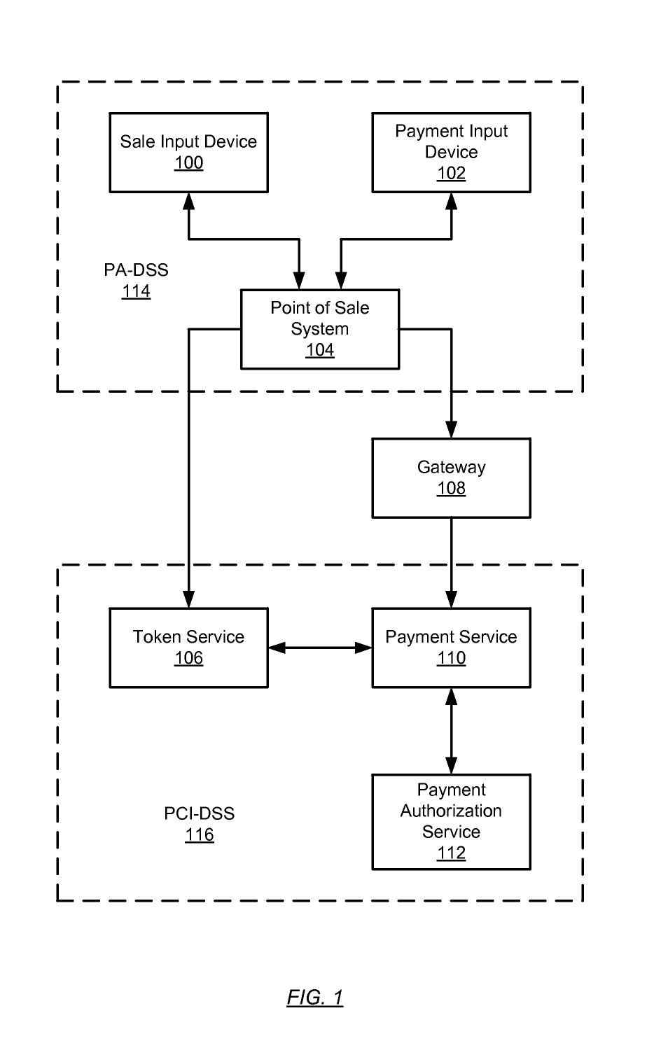

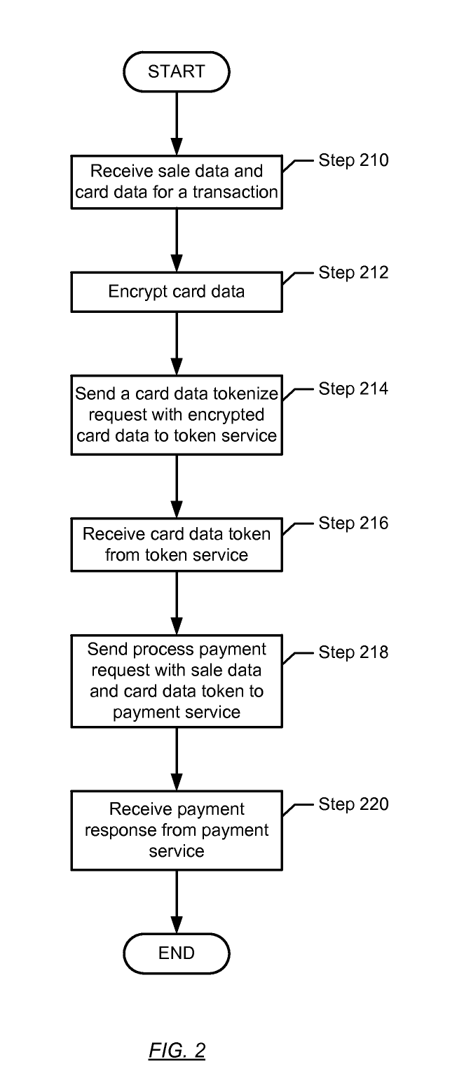

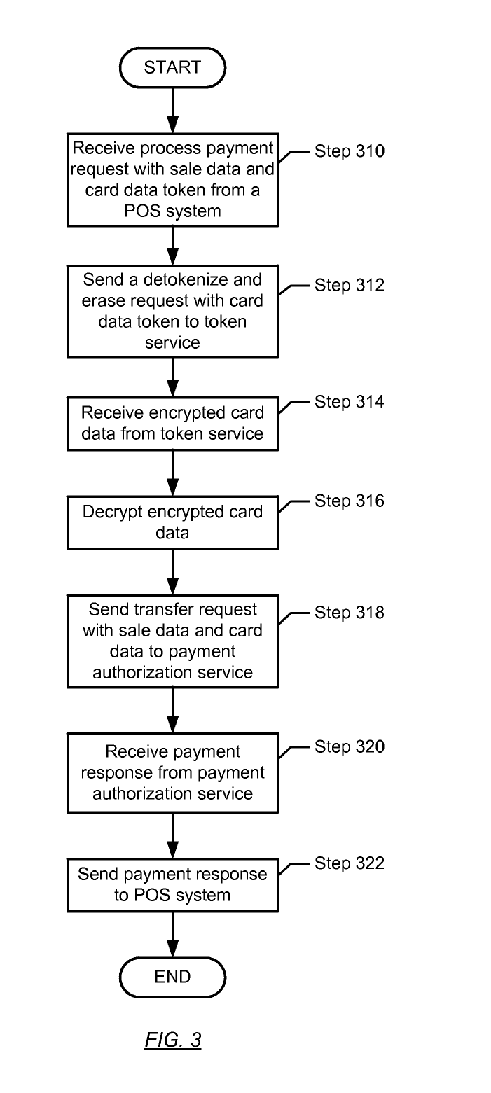

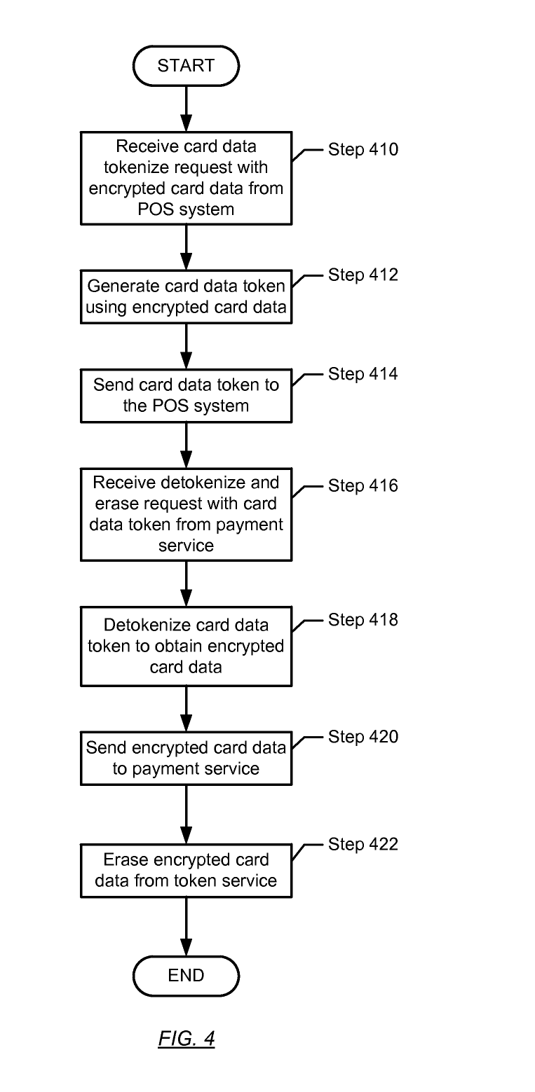

In one or more embodiments of the invention, the token service (106) is a combination of hardware and software with functionality to receive card data and securely store the card data as tokenized card data. The token service (106) may further include functionality to provide a card data token keyed to the card data. In one or more embodiments of the invention, the token service (106) is configured to delete existing tokenized card data once the card data is read or once the token has expired. The tokenized card data may be encrypted for storage. Additional information about the functionality of the token service (106) is provided in FIG. 4.

In one or more embodiments of the invention, the gateway (108) is a combination of hardware and software that includes functionality to facilitate communication between the POS system (104) and the payment service (110). In one or more embodiments of the invention, the gateway (108) does not store card data and is therefore out of scope of both the PA-DSS (114) and the PCI-DSS (116). For example, the gateway (108) may be an arbitrary intermediary system. In other words, after tokenization, a request may be routed through an arbitrary number of gateways (e.g. 0 to n).

In one or more embodiments of the invention, the payment service (110) is a combination of hardware and software that includes functionality to receive a payment request and processes the payment by communicating with the token service (106) and the payment authorization server (112). Additional information about the functionality of the payment service (110) is provided in FIG. 3.

In one or more embodiments of the invention, the payment authorization service (112) is a combination of hardware and software that includes functionality to authorize a payment using card data and sales data received from the payment service (110). Specifically, the payment authorization service (112) may include functionality to use the sale data to transfer funds between the account identified by the card data and an account of the payee.

In one or more embodiments of the invention, the PA-DSS (114) is a set of security requirements for third party payment applications used by a merchant. In one or more embodiments of the invention, the PCI-DSS (116) is a set security requirements for payment processing systems that store, processes, or transmit card data.

FIG. 2 shows a flowchart for processing a payment by the POS system in accordance with one or more embodiments of the invention. While the various steps in the flowchart are presented and described sequentially, one of ordinary skill will appreciate that some or all of the steps may be executed in different orders, may be combined or omitted, and some or all of the steps may be executed in parallel.

In Step 210, the POS system receives the sale data and card data for a transaction. In one or more embodiments of the invention, the sale data is received from a user via a sale input device. In one or more embodiments of the invention, the card data is received from a payment input device. In Step 212, the POS system encrypts the card data to obtain encrypted card data. In Step 214, the POS system sends a card data tokenize request that includes the encrypted card data to a token service. Those skilled in the art will appreciate that the card data does not need to be encrypted to be tokenized.

In Step 216, the POS system receives the card data token from the token service in response to the card data tokenize request. In Step 218, the POS system sends a process payment request that includes the sale data and card data token to the payment service. In one or more embodiments of the invention, the process payment request is sent to a gateway that directs the process payment request to the payment service.

In Step 220, the POS system receives a payment response from the payment service. In one or more embodiments of the invention, the payment response is received via a gateway. In one or more embodiments of the invention, the payment response includes an indication regarding whether the payment was successfully processed.

FIG. 3 shows a flowchart for processing a payment by the payment service in accordance with one or more embodiments of the invention. While the various steps in the flowchart are presented and described sequentially, one of ordinary skill will appreciate that some or all of the steps may be executed in different orders, may be combined or omitted, and some or all of the steps may be executed in parallel.

In Step 310, the payment service receives a process payment request with sale data and a card token from a POS system. In one or more embodiments of the invention, the process payment request is received via a gateway.

In Step 312, the payment service sends a detokenize and erase request that includes the card data token to the token service. In one or more embodiments of the invention, a detokenize and erase request instructs the token service to return the encrypted card data to the payment service and erase (immediately or almost immediately) the encrypted card data from the token service.

In Step 314, the payment service receives the encrypted card data keyed to the card data token from the token service. In Step 316, the payment service decrypts the encrypted card data to obtain decrypted card data. In Step 318, the payment service sends an authorize payment request (i.e. a transfer request) including the sale data and the decrypted card data to the payment authorization service. In one or more embodiments of the invention, the card data is reencrypted for secure transmission to the payment authorization service.

In Step 320, the payment service receives a payment response from the payment authorization service in response to the process payment request. In Step 322, the payment service sends the payment response to the POS system. In one or more embodiments of the invention, the payment response is sent to the POS system via a gateway.

FIG. 4 shows a flowchart for processing a payment by the token service in accordance with one or more embodiments of the invention. While the various steps in the flowchart are presented and described sequentially, one of ordinary skill will appreciate that some or all of the steps may be executed in different orders, may be combined or omitted, and some or all of the steps may be executed in parallel.

In Step 410, the token service receives a card data tokenize request that includes encrypted card data from a POS system. In one or more embodiments of the invention, the card data tokenize request includes a time to life (TTL) value. In one or more embodiment of the invention, a TTL value indicates the maximum amount of time the token service should maintain the card data in storage before deleting it. In other words, the token may live at most an amount of time equal to the TTL value, so even if the explicit detokenize and erase operation fails, the token will be erased. Those skilled in the art will appreciate that there may be various other modes of operation, and that the token may function in other ways not described.

In Step 412, the token service generates the card data token from the encrypted card data. In one or more embodiments of the invention, the encrypted card data is stored on the token service keyed to the card data token. In one or more embodiments of the invention, the card data token may be a sequence of characters matching the format of the card data. For example, one may tokenize encrypted track data or cleartext card data (either of which may originate from the POS System). In Step 414, the token service sends the card data token to the POS system.

In Step 416, the token service receives a detokenize and erase request with the card data token from a payment service. In one or more embodiments of the invention, detokenizing refers to providing the card data (or encrypted card data) to the payment service in response to receiving the corresponding card data token.

In Step 418, the token service detokenizes the card data to obtain the corresponding encrypted card data. In one or more embodiments of the invention, the token service first determines whether the card data corresponding to the card data token exists on the token service. In one or more embodiments of the invention, the card data may have been deleted based on the expiration of the TTL associated with the card data. In the event that the card data token has been deleted, the token service may respond with a message indicated that the TTL for the requested card data token has expired and the card data token has been deleted.

In Step 420, the token service sends the encrypted card data to the payment service. In Step 422, the token service erases (i.e. deletes) the encrypted card data from the token service.

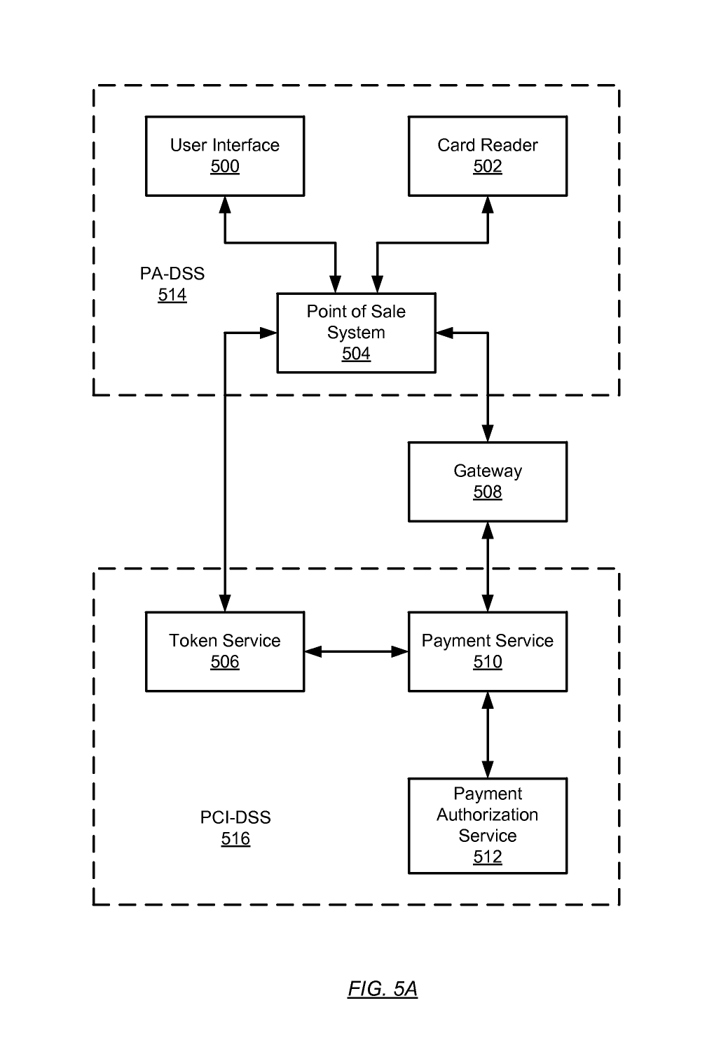

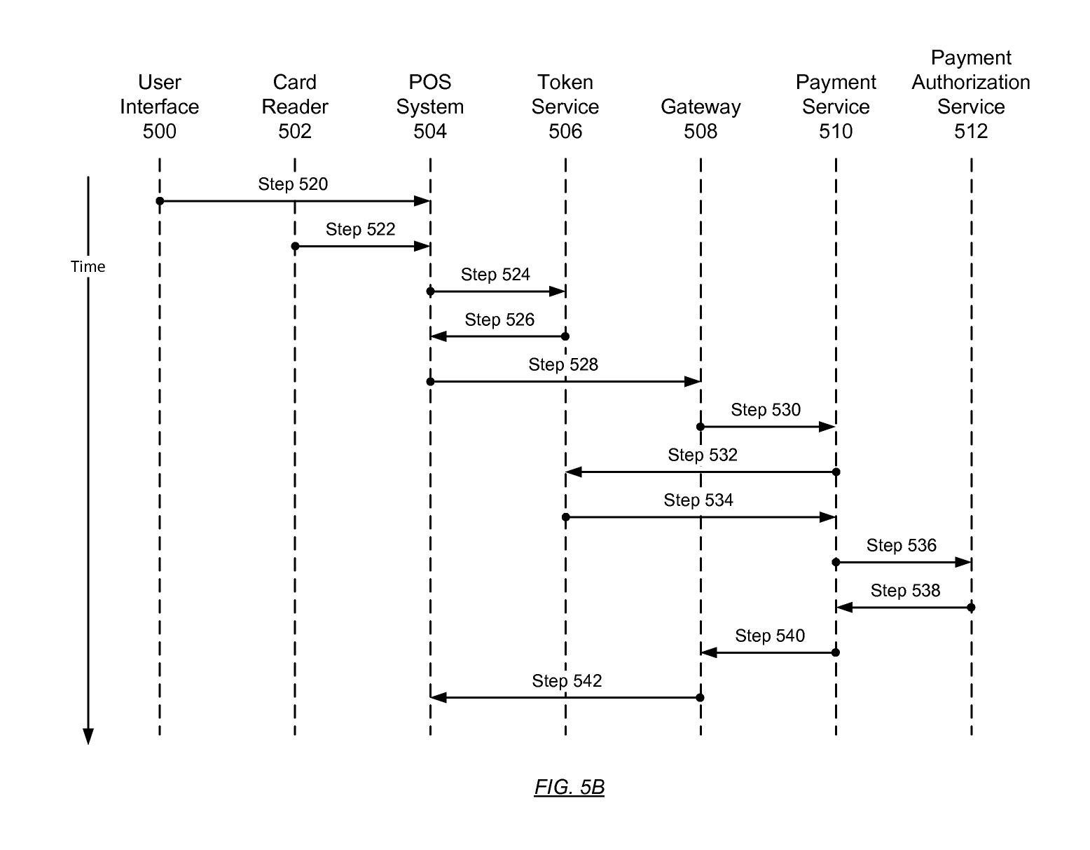

FIGS. 5A and 5B show an example in accordance with one or more embodiments of the invention. Specifically, FIG. 5A shows an example system in accordance with one or more embodiments of the invention. As shown in FIG. 5A, the example system includes a touchscreen user interface (500), a card reader (502), a POS system (504), a token service (506), a gateway (508), a payment service (510), and an payment authorization service (512). The sale input device (500), the payment input device (502), and the POS system (504) are governed by the PA-DSS (514). The token service (506), the payment service (508), and the payment authorization service (510) are governed by the PCI-DSS (516). The gateway (508) is out of the scope of both the PA-DSS (514) and the PCI-DSS (516).

FIG. 5B shows an example timeline in accordance with one or more embodiments of the invention. For the purposes of the example, assume that the POS system is employed by a company called Haircutes, Inc. Further, assume that the current transaction is initiated when a customer Mary is attempting to pay $37.00 for a haircut using a credit card.

In Step 520, a Haircutes employee enters the sale data into the POS system (504) using the touchscreen user interface (500). For the purposes of the example, assume that the sale data includes the fields “amt=$37.00” and “payee=Haircutes”. In Step 522, Mary swipes her credit card using card reader (502), which then transmits the card data to the POS system (504) where it is encrypted.

In Step 524, the POS system (504) generates a card data tokenize request with the encrypted card data and a TTL value of 3 minutes, and sends the card data tokenize request to the token service (506). In Step 526, the token service (506) stores the encrypted card data with the TTL value on the token service (506) and generates a card data token keyed to the encrypted card data. Also in Step 526, the token service (506) sends the card data token to the POS system (504).

In Step 528, the POS system (504) generates a process payment request using the sale data and card data token, and sends the process payment request to the gateway (508). In Step 530, the gateway (508) directs the process payment request to the payment service (510).

In Step 532, the payment service (510) generates a detokenize and erase request using the card data token and sends the detokenize and erase request to the token service (506). In Step 534, the token service (506) obtains the encrypted card data using the card data token and sends the encrypted card data to the payment service (510). Assume that the encrypted card data still exists on the token service because the TTL of 3 minutes has not yet expired. Also at Step 534, the token service (506) deletes the encrypted card data from the token service (506).

In Step 536, the payment service (510) decrypts the encrypted card data and generates a transfer request using the card data and the sale data. Also in Step 536, the payment service (510) sends the transfer request to the payment authorization service (512). In Step 538, the payment authorization service coordinates the transfer of $37.00 from Mary's credit card company to Haircute, Inc.'s account. For the purposes of the example, assume that the transfer is successful. Also in Step 538, the payment authorization service generates a payment response indicating the transfer was successful, and sends the payment response to the gateway (508). In Step 540, the gateway (508) directs the payment response to the POS system (504), where the Haircute employee is notified that the payment has been accepted.

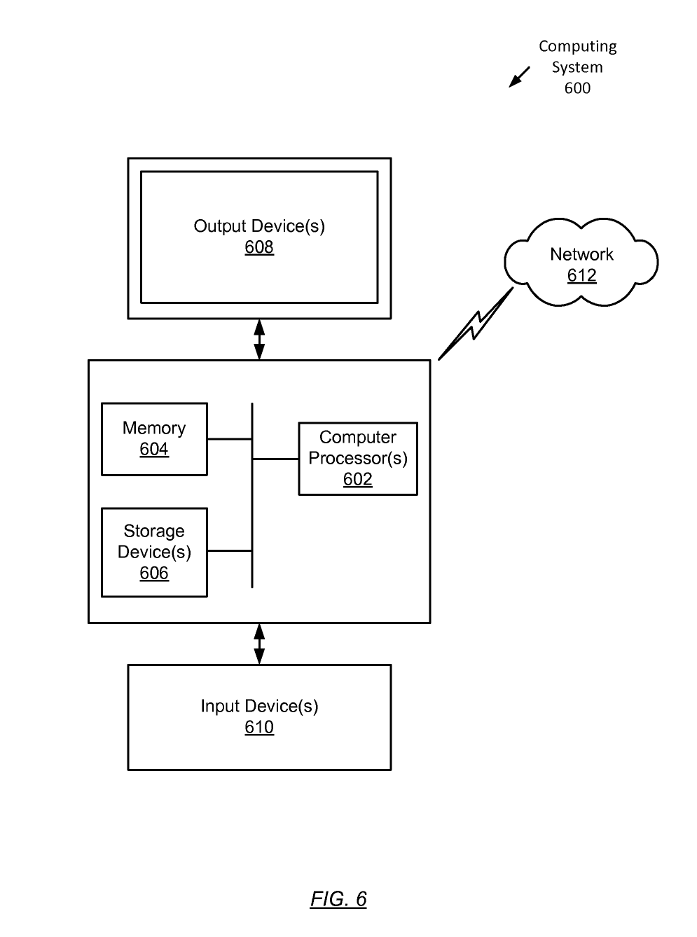

Embodiments of the invention may be implemented on virtually any type of computing system regardless of the platform being used. For example, the computing system may be one or more mobile devices (e.g., laptop computer, smart phone, personal digital assistant, tablet computer, or other mobile device), desktop computers, servers, blades in a server chassis, or any other type of computing device or devices that includes at least the minimum processing power, memory, and input and output device(s) to perform one or more embodiments of the invention. For example, as shown in FIG. 6, the computing system (600) may include one or more computer processor(s) (602), associated memory (604) (e.g., random access memory (RAM), cache memory, flash memory, etc.), one or more storage device(s) (606) (e.g., a hard disk, an optical drive such as a compact disk (CD) drive or digital versatile disk (DVD) drive, a flash memory stick, etc.), and numerous other elements and functionalities. The computer processor(s) (602) may be an integrated circuit for processing instructions. For example, the computer processor(s) may be one or more cores, or micro-cores of a processor. The computing system (600) may also include one or more input device(s) (610), such as a touchscreen, keyboard, mouse, microphone, touchpad, electronic pen, or any other type of input device. Further, the computing system (600) may include one or more output device(s) (608), such as a screen (e.g., a liquid crystal display (LCD), a plasma display, touchscreen, cathode ray tube (CRT) monitor, projector, or other display device), a printer, external storage, or any other output device. One or more of the output device(s) may be the same or different from the input device(s). The computing system (600) may be connected to a network (612) (e.g., a local area network (LAN), a wide area network (WAN) such as the Internet, mobile network, or any other type of network) via a network interface connection (not shown). The input and output device(s) may be locally or remotely (e.g., via the network (612)) connected to the computer processor(s) (602), memory (604), and storage device(s) (606). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that when executed by a processor(s), is configured to perform embodiments of the invention.

Further, one or more elements of the aforementioned computing system (600) may be located at a remote location and connected to the other elements over a network (612). Further, embodiments of the invention may be implemented on a distributed system having a plurality of nodes, where each portion of the invention may be located on a different node within the distributed system. In one embodiment of the invention, the node corresponds to a distinct computing device. Alternatively, the node may correspond to a computer processor with associated physical memory. The node may alternatively correspond to a computer processor or micro-core of a computer processor with shared memory and/or resources.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method comprising:
receiving, by a payment service from a point of sale (POS) system, a payment request comprising sale data and a card data token;
generating a detokenize and erase request comprising the card data token;
sending the detokenize and erase request to a token service;
receiving, by the payment service using a computer processor, card data from the token service in response to the sending the detokenize and erase request;
generating a payment process request comprising the sale data and the card data;
sending the payment process request to an payment authorization service;
receiving a payment response from the payment authorization service in response to the sending the payment process request; and
sending the payment response to the POS system.

2. The method of claim 1,
wherein the payment request is received via a gateway.

3. The method of claim 2, wherein the payment service is governed by a payment application data security standard.

4. The method of claim 3, wherein the gateway is excluded from payment application data security standard governance.

5. The method of claim 1, wherein the card data token is generated by the token service in response to receiving a card data tokenize request from the POS system.

6. The method of claim 5, wherein the card data tokenize request comprises a time to life for the card data.

7. The method of claim 6, wherein the token service determines that the time to life for the card data has not expired.

8. The method of claim 1, wherein the token service securely deletes the card data from the token service associated to the token in response to providing the card data to the payment service.

9. A non-transitory computer readable medium comprising instructions that, when executed by a computer processor, perform a method, the method comprising:
receiving, by a payment service from a point of sale (POS) system, a payment request comprising sale data and a card data token;
generating a detokenize and erase request comprising the card data token;
sending the detokenize and erase request to a token service;
receiving, by the payment service, card data from the token service in response to the sending the detokenize and erase request;
generating a payment process request comprising the sale data and the card data;
sending the payment process request to the payment authorization service;
receiving a payment response from the payment authorization service in response to the sending the payment process request; and
sending the payment response to the POS system.

10. The non-transitory computer readable medium of claim 9,
wherein the payment request is received via a gateway.

11. The non-transitory computer readable medium of claim 10, wherein the payment service is governed by a payment application data security standard.

12. The non-transitory computer readable medium of claim 11, wherein the gateway is excluded from payment application data security standard governance.

13. The non-transitory computer readable medium of claim 9, wherein the card data token is generated by the token service in response to receiving a card data tokenize request from the POS system.

14. The non-transitory computer readable medium of claim 13, wherein the card data tokenize request comprises a time to life for the card data.

15. The non-transitory computer readable medium of claim 14, wherein the token service determines that the time to life for the card data has not expired.

16. The non-transitory computer readable medium of claim 9, wherein the token service deletes the card data from the token service associated to the token in response to providing the card data to the payment service.

17. A system comprising:
a token service configured to:
receive, from a point of sale (POS) system, a card data tokenize request comprising card data,
generate a card data token corresponding to the card data, and
send the card data token to the POS system; and
a payment service configured to:
receive, from the POS system, a payment request comprising sale data and the card data token,
generate a detokenize and erase request comprising the card data token,
send the detokenize and erase request to the token service,
receive, by the payment service, card data from the token service in response to the sending the detokenize and erase request,
generate a payment process request comprising the sale data and the card data,
send the payment process request to a payment authorization service,
receive a payment response from the payment authorization service in response to the sending the payment process request, and
send the payment response to the POS system.

18. The system of claim 17, further comprising:
a gateway, wherein the payment request is received via the gateway.

19. The system of claim 18, wherein the payment service is governed by a payment application data security standard.

20. The system of claim 19, wherein the gateway is excluded from payment application data security standard governance.

21. The system of claim 17, wherein the token service deletes the card data from the token service associated to the token in response to providing the card data to the payment service.

22. The system of claim 17, wherein the card data token is generated by the token service in response to receiving a card data tokenize request from the POS system.

23. The system of claim 21, wherein the card data tokenize request comprises a time to life for the card data.

24. The system of claim 23, wherein the token service determines that the time to life for the card data has not expired.

25. The system of claim 23, wherein the token service deletes the card data from the token service in response to not receiving a detokenize request within the time to life limit.
